(19) United States
(12) Patent Application Publication
(10) Pub. No.: US 2017/0329737 A1
(43) Pub. Date: Nov. 16, 2017

(54) TWO-WIRE LINE-MULTIPLEXED UART TO FOUR-WIRE HIGH-SPEED UART BRIDGING WITH INTEGRATED FLOW CONTROL

(71) Applicant: QUALCOMM Incorporated, San Diego, CA (US)

(72) Inventors: Nitinkumar Barot, San Jose, CA (US); Lalan Jee Mishra, San Diego, CA (US); Richard Dominic Wietfeldt, San Diego, CA (US)

(21) Appl. No.: 15/151,682

(22) Filed: May 11, 2016

(51) Int. Cl. G06F 13/42; G06F 13/362

(52) U.S. Cl. CPC G06F 13/4282; G06F 13/362

(57) ABSTRACT

Systems, methods, and apparatus for bridging between different types of serial interface are disclosed. A method performed by a bridge circuit includes synchronizing transmissions on a 4-wire serial interface with transmissions on a 2-wire serial interface when a stop bit is detected on data lines of at least one interface, receiving a first clear-to-send notification from a first wire of the 2-wire serial interface, asserting a request-to-send signal on a first flow-control line of the 4-wire serial interface, receiving data bits from a first data line of the 4-wire serial interface while the request-to-send signal is asserted, and transmitting the data bits on the first wire of the 2-wire serial interface after receiving the first clear-to-send notification.

### TECHNICAL FIELD

The present disclosure relates generally to peripheral communications interfaces, and more particularly to integrating interface devices that communicate flow-control signals using reduced pin counts with interface devices that communicate flow-control signals using a pin for each signal.

### BACKGROUND

Mobile communication devices may include a variety of components including circuit boards, integrated circuit (IC) devices and/or System-on-Chip (SoC) devices. The components may include processing circuits, user interface components, storage and other peripheral components. Communication between components may be implemented using universal asynchronous receiver/transmitter (UART) devices. In many interfaces, 4-wire UART devices transmit data on one wire (Tx wire), receive data on another wire (Rx wire), and use two wires to carry flow-control signals. One flow-control signal is the request-to-send (RTS) signal which may be used to indicate that the UART has data to be transmitted. The other flow-control signal is the clear-to-send (CTS) signal which is received at the UART and may be used to indicate that the UART can transmit data.

Increasing functionality and denser input/output (I/O) configurations can result in a demand for reduced pin-count in interfaces used to interconnect SoC and/or other IC devices. The line-multiplexed universal asynchronous receiver/transmitter (LM-UART) is a UART that uses two wires to carry Rx, Tx, RTS and CTS signals by multiplexing RTS and CTS between data transmissions on the Rx and Tx wires to reduce the number of I/O connections while maintaining the capability to support a hardware-based flow control mechanism in full-duplex modes of operation.

Manufacturers of mobile devices, such as cellular phones, may obtain components of the mobile devices from various sources, including different manufacturers. For example, an application processor in a cellular phone may be obtained from a first manufacturer, while a modem for the cellular phone may be obtained from a second manufacturer. The application processor and the modem or other device may be interconnected using UARTs. Some devices may include LM-UART and support modes of operation using two wires and multiplexed flow-control, while other devices may include conventional 4-wire UARTs. Accordingly, there is a need to interconnect devices that employ 4-wire UARTs with devices that have 2-wire LM-UARTs.

### SUMMARY

Certain aspects of the disclosure relate to systems, apparatus, methods and techniques that bridge between a first full-duplex multi-wire serial interface that operates using hardware flow control and a second full-duplex multi-wire serial interface that operates using multiplexed data and flow-control signals.

In various aspects of the disclosure, a method is performed by a bridge circuit and includes synchronizing transmissions on a 4-wire serial interface with transmissions on a 2-wire serial interface when a stop bit is detected on data lines of at least one interface, receiving a first clear-to-send notification from a first wire of the 2-wire serial interface, asserting a request-to-send signal on a first flow-control line of the 4-wire serial interface, receiving data bits from a first data line of the 4-wire serial interface while the request-to-send signal is asserted, and transmitting the data bits on the first wire of the 2-wire serial interface after receiving the first clear-to-send notification.

In one aspect, the request-to-send signal may be asserted when the first clear-to-send notification is received.

In another aspect, the method includes receiving a second clear-to-send notification from the first wire of the 2-wire serial interface after the data bits have been transmitted on the first wire of the 2-wire serial interface, and de-asserting the request-to-send signal on the first flow-control line of the 4-wire serial interface in response to the second clear-to-send notification. The first and second clear-to-send notifications may be received between 8-bit transmissions on the first wire of the 2-wire serial interface.

In certain aspects, the method includes determining that a clear-to-send signal has been asserted on a second flow-control line of the 4-wire serial interface, transmitting a first request-to-send notification over a second wire of the 2-wire serial interface, receiving data bits from the second wire of the 2-wire serial interface after the first request-to-send notification has been transmitted, and transmitting the data bits on a second data line of the 4-wire serial interface while the clear-to-send signal is asserted. The first request-to-send notification may be transmitted when the clear-to-send signal is asserted.

The method may include determining that the clear-to-send signal has been de-asserted, and transmitting a second request-to-send notification over the second wire of the 2-wire serial interface after the data bits have been received when the clear-to-send signal has been de-asserted. The first request-to-send notification may be transmitted between 8-bit packets received from the second wire of the 2-wire serial interface.

In some aspects, the method includes identifying a type of a first UART coupled to a first interface of the bridge circuit, identifying a type of a second UART coupled to a second interface of the bridge circuit, and configuring a bridging operation based on the type of the first UART and the type of the second UART.

The method may further include configuring the first interface as a 2-wire interface when the first UART is a line-multiplexed UART, and configuring the first interface as a 4-wire interface when the first UART is not a line-multiplexed UART.

The method may further include configuring the second interface as a 2-wire interface when the second UART is a line-multiplexed UART, and configuring the second interface as a 4-wire interface when the second UART is not a line-multiplexed UART.

The method may further include identifying a change in the type of the first UART or the type of the second UART, and modifying a bridging operation based on the change in the type of the first UART or the type of the second UART.

In another aspect, configuring the bridging operation includes multiplexing onto a first wire of the first interface, a first data signal that is received from the second interface with a first flow-control signal that is transmitted on the second interface, and multiplexing onto a second wire of the first interface, a second data signal that is transmitted on the second interface with a second flow-control signal that is received from the second interface.

In various aspects of the disclosure, an apparatus includes means for synchronizing transmissions on a 4-wire serial interface with transmissions on a 2-wire serial interface when a stop bit is detected on data lines of at least one interface, means for receiving a first clear-to-send notification from a first wire of the 2-wire serial interface, means for asserting a request-to-send signal on a first flow-control line of the 4-wire serial interface, means for receiving data bits from a first data line of the 4-wire serial interface while the request-to-send signal is asserted, and means for transmitting the data bits on the first wire of the 2-wire serial interface after receiving the first clear-to-send notification.

In various aspects of the disclosure, an apparatus includes a plurality of multi-wire interfaces, one or more buffers and a controller configured to synchronize transmissions on a 4-wire serial interface with transmissions on a 2-wire serial interface when a stop bit is detected on data lines of at least one interface, receive a first clear-to-send notification from a first wire of the 2-wire serial interface, assert a request-to-send signal on a first flow-control line of the 4-wire serial interface, receive data bits from a first data line of the 4-wire serial interface while the request-to-send signal is asserted, and transmit the data bits on the first wire of the 2-wire serial interface after receiving the first clear-to-send notification.

In various aspects of the disclosure, a processor-readable storage medium is disclosed. The storage medium may be a non-transitory storage medium and may store code that, when executed by one or more processors, causes the one or more processors to synchronize transmissions on a 4-wire serial interface with transmissions on a 2-wire serial interface when a stop bit is detected on data lines of at least one interface, receive a first clear-to-send notification from a first wire of the 2-wire serial interface, assert a request-to-send signal on a first flow-control line of the 4-wire serial interface, receive data bits from a first data line of the 4-wire serial interface while the request-to-send signal is asserted, and transmit the data bits on the first wire of the 2-wire serial interface after receiving the first clear-to-send notification.

In certain aspects, the storage medium may store code that causes the one or more processors to determine when a clear-to-send signal has been asserted on a second flow-control line of the 4-wire serial interface, transmit a first request-to-send notification over a second wire of the 2-wire serial interface, receive data bits from the second wire of the 2-wire serial interface after the first request-to-send notification has been transmitted, and transmit the data bits on a second data line of the 4-wire serial interface while the clear-to-send signal is asserted. The first request-to-send notification may be transmitted when the clear-to-send signal is asserted.

### BRIEF DESCRIPTION OF THE DRAWINGS

FIG. 1 illustrates one example of an apparatus that may be adapted according to certain aspects disclosed herein.

FIG. 2 illustrates an example of a serial interface based on a 4-wire high-speed universal asynchronous receiver/transmitter device (HS-UART), and an example of a serial interface based on a 2-wire LM-UART.

FIG. 3 illustrates a single-wire interface in an LM-UART, which may be employed in accordance with certain aspects disclosed herein.

FIG. 4 illustrates configurations of devices that include 4-wire HS-UARTs and/or 2-wire LM-UARTs.

FIG. 5 illustrates configurations of devices that may be coupled to test equipment using 4-wire HS-UARTs or 2-wire LM-UARTs.

FIG. 6 illustrates an example of a 2-wire LM-UART to 4-wire HS-UART bridge circuit in accordance with certain aspects disclosed herein.

FIG. 7 illustrates examples of apparatus in which an LM-UART and a 4-wire HS-UART are interconnected using a bridge circuit adapted according to certain aspects disclosed herein.

FIG. 8 illustrates examples of apparatus and test equipment in which an LM-UART and a 4-wire HS-UART are interconnected using a bridge circuit adapted according to certain aspects disclosed herein.

FIG. 9 illustrates a first connector that may be used to connect external equipment to an apparatus using a bridge circuit provided in accordance with certain aspects disclosed herein.

FIG. 10 illustrates a second connector that may be used to connect external equipment to an apparatus using a bridge circuit provided in accordance with certain aspects disclosed herein.

FIGS. 11 and 12 illustrate bridging operations associated with a bridge circuit provided in accordance with certain aspects disclosed herein.

FIG. 13 illustrates an example of a hot-plug process that may be implemented in accordance with certain aspects disclosed herein.

FIG. 14 is a block diagram illustrating an example of an apparatus employing a processing circuit that may be adapted according to certain aspects disclosed herein.

FIG. 15 is a flowchart of a method for operating a bridging circuit in accordance with certain aspects disclosed herein.

FIG. 16 is a diagram illustrating an example of a hardware implementation for an apparatus that can bridge between 4-wire and 2-wire serial interfaces in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

Devices that include multiple SoC and other IC devices often employ a serial bus to connect processors with modems and other peripherals. In some instances, it may be desirable to connect a 2-wire LM-UART of an application-specific integrated circuit (ASIC) or SoC to a conventional modem that has a conventional high-speed, 4-wire UART. The 4-wire UART may be provided in an IC device within the apparatus, or in test equipment such as a standard personal computer (PC).

According to certain aspects disclosed herein, a bridge circuit can convert signaling generated by conventional UARTs to signaling compatible with LM-UARTs, and can convert signaling generated by LM-UARTs to signaling compatible with conventional UARTs. In some examples, the bridge circuit may determine the types of UART to which it is connected and configure a mode of operation based on the configuration. For example, the bridge may enable multiplexing and other signal conversion circuits when communication is to be established between a LM-UART and a conventional 4-wire UART.

Example of an Apparatus with a Serial Data Link

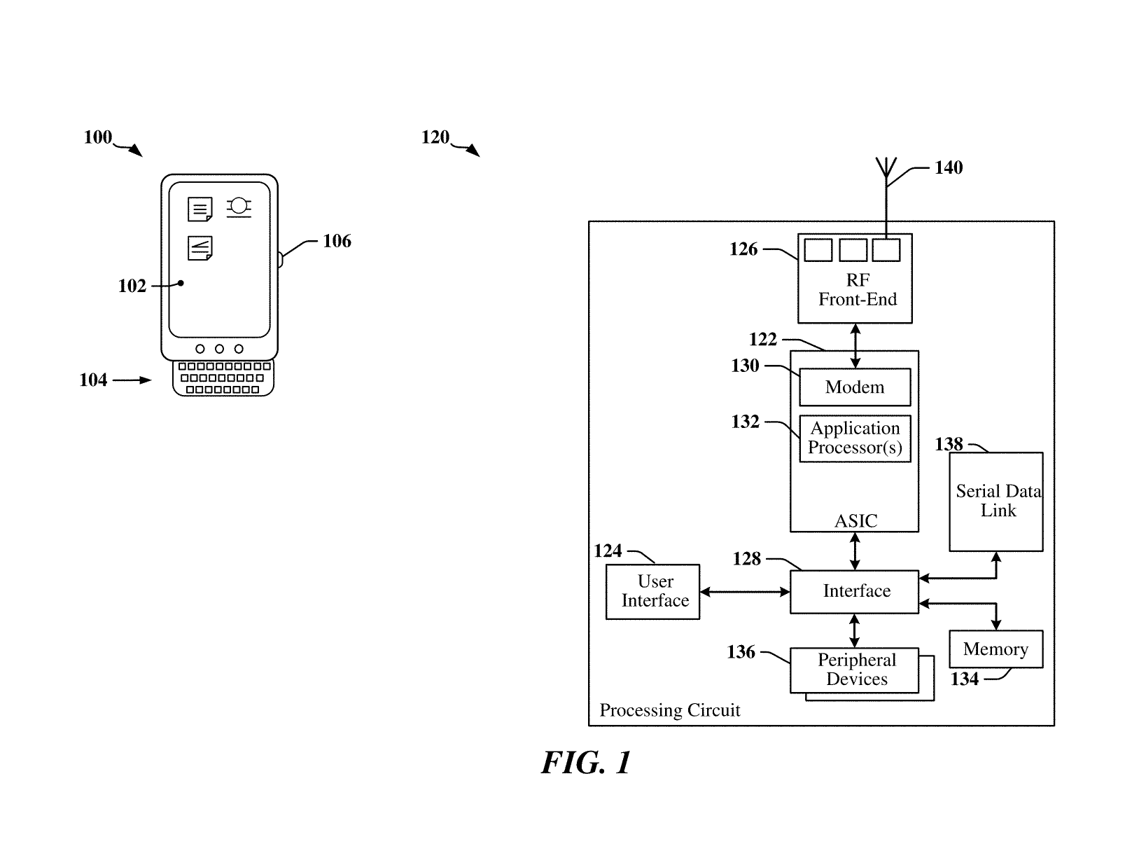

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device. FIG. 1 depicts an example of such an apparatus 100. The apparatus 100 may include a processing circuit 120 having multiple devices or circuits 122, 124, 126, 128, 134, 136, and/or 138. The processing circuit 120 may be implemented in an ASIC or SoC that may include multiple devices or circuits 122, 124, 126, 128, 134, 136, and/or 138. In one example, the apparatus 100 may be a communication device and the processing circuit 120 may include an RF front-end circuit 126 that enables the apparatus to communicate through one or more antennas 140 with a radio access network, a core access network, the Internet and/or another network.

In the example illustrated in FIG. 1, the processing circuit 120 includes an ASIC device 122 that has one or more processors 132, one or more modems 130, and/or other logic circuits or functions. The processing circuit 120 may be controlled by an operating system and may provide an application programming interface (API) layer that enables the one or more processors 132 to execute software modules residing in the memory device 134, for example. The software modules may include instructions and data stored in a processor readable storage such as the memory device 134. The ASIC device 122 may access its internal memory, the memory device 134 of the processing circuit 120, and/or external memory. Memory may include read-only memory (ROM) or random-access memory (RAM), electrically erasable programmable ROM (EEPROM), flash cards, or any memory device that can be used in processing systems and computing platforms. The processing circuit 120 may include, or have access to a local database or other parameter storage that can maintain operational parameters and other information used to configure and operate the apparatus 100 and/or the processing circuit 120. The local database may be implemented using registers, a database module, flash memory, magnetic media, EEPROM, optical media, tape, soft or hard disk, or the like. The processing circuit 120 may also be operably coupled to external devices such as the antenna 140, a display 102, operator controls, such as a button 106 and/or an integrated or external keypad 104, among other components. A user interface 124 may communicate with the display 102, keypad 104, etc. through a dedicated communication link 138 or through one or more serial data interconnects.

The processing circuit 120 may communicate through one or more interface circuits 128, which may include a combination of circuits, counters, timers, control logic and other configurable circuits or modules. In one example, the interface circuit 128 may be configured to operate in accordance with communication specifications or protocols. The processing circuit 120 may include or control a power management function that configures and manages the interface 128, the user interface 124, the RF front-end circuit 126, and the operation of one or more application processors 132 resident in the ASIC device 122, for example.

Overview of the LM-UART

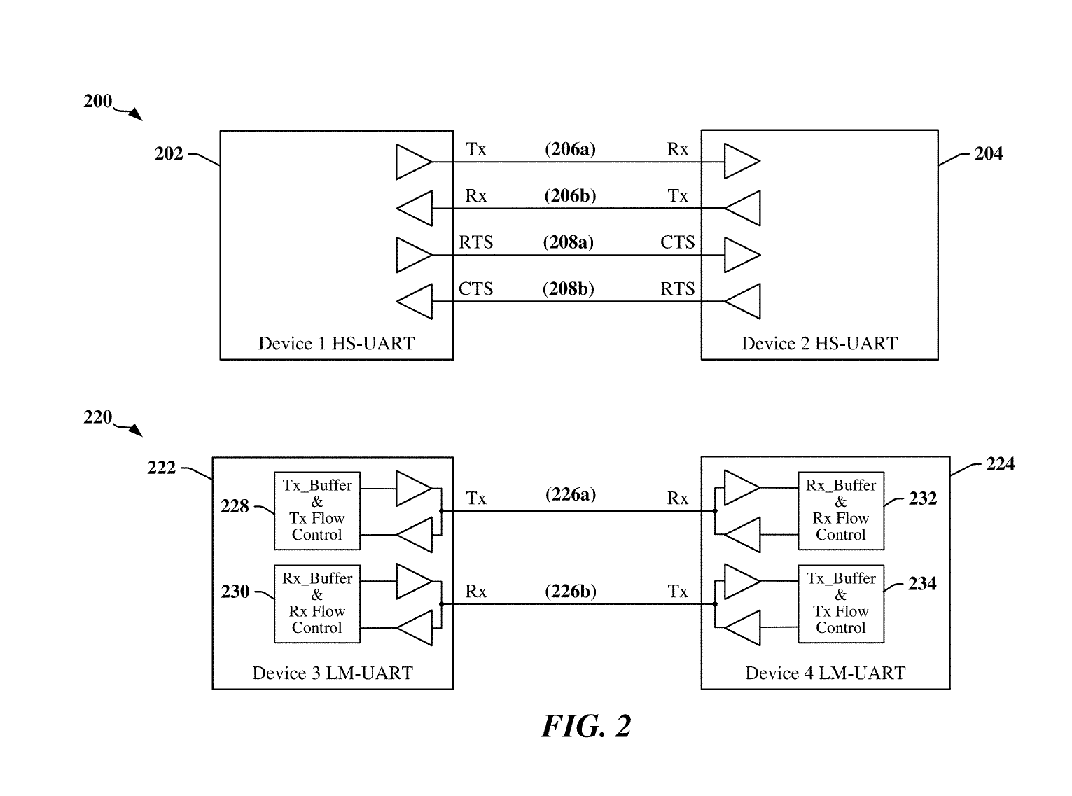

FIG. 2 illustrates an example 200 of a serial interface that employs a conventional, 4-wire UART device and an example 220 of a serial interface that use a 2-wire LM-UART device. In the first example 200, two 4-wire HS-UARTs 202, 204 implement a full-duplex link with hardware flow-control over four wires 206a, 206b, 208a, 208b. Data is transmitted over two wires 206a and 206b. For example, data is transmitted by the first HS-UART 202 over a first wire 206a and received by the first HS-UART 202 from a second wire 206b. Data is received by the second HS-UART 204 from the first wire 206a and the second HS-UART 204 may transmit data over the second wire 206b. The first HS-UART 202 transmits its RTS signal over a third wire 208a to the CTS input of the second HS-UART 204. The CTS signal received by the first HS-UART 202 from a fourth wire 208b is transmitted as the RTS signal of the second HS-UART 204.

In one mode of operation, each HS-UART 202, 204 transmits a frame only when an active signaling state is detected on the CTS signal (e.g. the CTS is at logic high level). The receiving HS-UART 204, 202 side asserts its RTS signal when it is ready to receive a new frame. RTS/CTS flow control may be managed by buffer control logic in each HS-UART 202, 204. The buffer control logic may be adapted to detect occupancy levels of transmit or receive buffers and, for example, an RTS signal may be asserted in accordance with the occupancy levels. The first HS-UART 202 may selectively control transmissions by the second HS-UART 204 using the RTS signal sent over the third wire 208a. The first HS-UART 202 may be selectively inhibited from transmitting data by the second HS-UART 204 using the RTS signal sent over the fourth wire 208b, which is received as CTS at the first HS-UART 202.

In the second example 220 illustrated in FIG. 2, two high-speed line-multiplexed universal asynchronous receiver/transmitter devices (LM-UARTs 222, 224) implement a full-duplex serial link with multiplexed hardware flow-control over two wires 226a, 226b. Data is transmitted in packets over the two wires 226a and 226b, with data packets transmitted by the first LM-UART 222 being carried over a first wire 226a to the Rx input of the second LM-UART 224. Data packets received at the Rx input of the first LM-UART 222 are transmitted by the second LM-UART 224 over the second wire 206b. Flow control information is transmitted between data packets on both wires 226a, 226b. In each LM-UART 222 or 224, a transmitter includes integrated data buffering and flow control logic 228 or 234 that may transmit data over a first wire 226a or 226b and receive flow control information (CTS) from the same first wire 226a or 226b. In each LM-UART 222 or 224, a receiver includes integrated data buffering and flow control logic 230 or 232 that may receive data from a second wire 226b or 226a and transmit flow control information (RTS) over the second wire 226b or 226a.

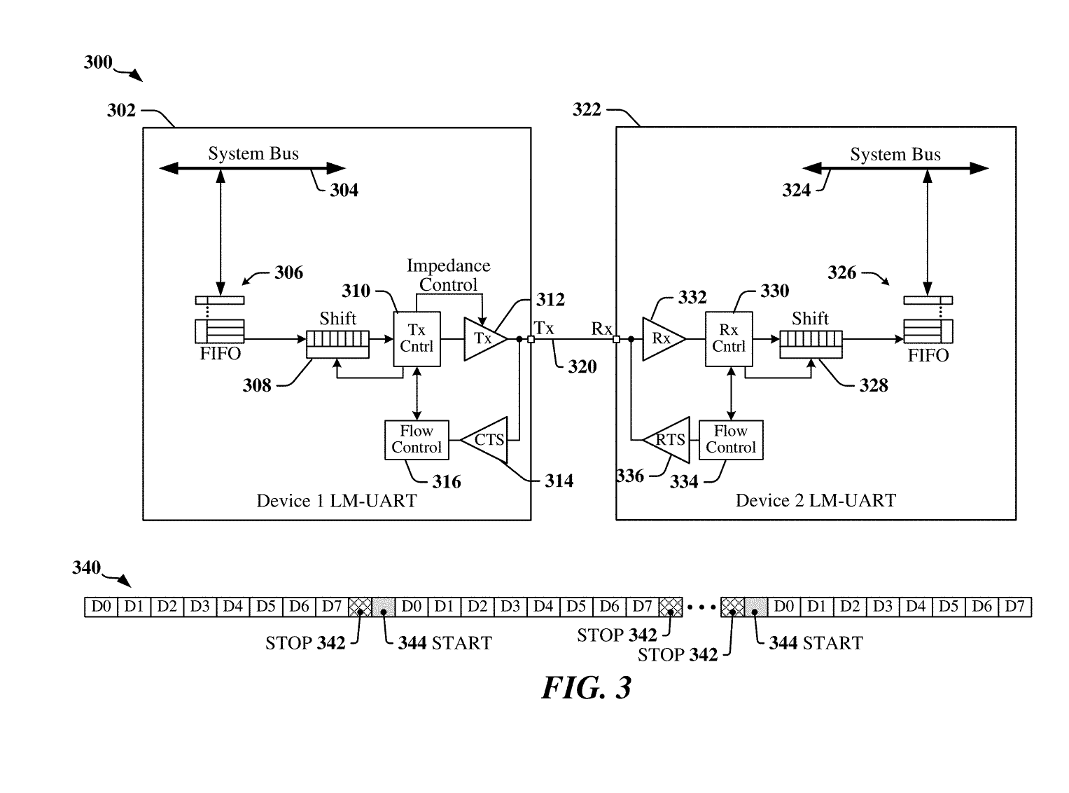

FIG. 3 illustrates a single-wire interface 300, which may be part of, or contribute to a full-duplex 2-wire serial data link. The single-wire interface 300 may be implemented using two LM-UARTs 302, 322. A transmitter circuit of the first LM-UART 302 is coupled to a receiver circuit of a second LM-UART 322 through a single wire 320. The data flow diagram 340 illustrates an example of packet transmission on the wire 320.

The first LM-UART 302 includes a line driver 312 used to transmit data packets over the wire 320. The output of the line driver may be in a high-impedance state between data packets while a line receiver 314 coupled to the wire 320 provides a signal representative of the signaling state of the wire 320 that is monitored by flow control logic 316. The flow control logic 316 determines the CTS state of the single-wire interface 300 between data packets. The CTS state is used by transmitter control logic 310 to determine whether the line driver 312 is to be enabled or placed in high-impedance mode, and to control the operation of a parallel-to-serial converter 308 (e.g., a shift circuit or register), and/or to control the operation of data buffers that may include one or more First-In-First-Out (FIFO 306) memory structures or registers. Data may be provided to the FIFO 306 through a system bus 304.

The second LM-UART 322 includes a line receiver 332 that receives data packets transmitted over the wire 320 by the transmitting LM-UART 302. The output of the line receiver 332 is provided to a serial-to-parallel converter 328 (e.g., a shift circuit or shift register) under the control of receiver control logic 330. The output of the serial-to-parallel converter 328 may be placed in a FIFO 326 for reading through a system bus 324, for example. The receiver control logic 330 may manage flow control logic 334 that is configured to transmit flow control information between data packets. In one example, the receiver control logic 330 may monitor the occupancy of the FIFO 326 and may determine when the FIFO 326 has exceeded a maximum data occupancy threshold. When the threshold is exceeded, the receiver control logic 330 may signal the flow control logic 334 to assert flow control. The receiver flow control logic 330 is configured to provide flow control information between data packets. In one example, the flow control logic 334 enables the RTS driver 336 when flow control is to be asserted such that the RTS driver 336 drives the wire 320 to a low voltage level (representing logic low state) after detecting termination of a packet in order to indicate that RTS is not asserted. When the threshold is not exceeded, the RTS driver 336 may remain inactive. After asserting flow control, the receiver control logic 330 may cause flow control logic 334 to indicate that RTS is asserted by driving the wire 320 to a high voltage level (representing logic high state), before releasing the wire 320 into a state equivalent to a stop bit 348.

In operation, 8-bit data packets communicated through LM-UARTs commence with a start bit 342a, 342b, 342c represented by a low voltage level on the wire 320, and terminate with a stop bit 344a, 344b, 344c represented by a high voltage level on the wire 320. The line driver 312 in the first LM_UART 302 may be adapted to drive the wire 320 to the high voltage level for a portion of the stop bit 344a, 344b, 344c before entering a high impedance state. In one example, the wire 320 remains at the high voltage level for the duration of a stop bit 344a, and a start bit 342b may be transmitted immediately as part of the next data packet. The wire 320 is maintained at the high voltage level by the output impedance of the line driver 312, and/or by a pull-up resistor or the like. In another example, a delay 346 occurs between transmission of a stop bit 344b and the next start bit 342c. The delay 346 may occur when there is no data to be transmitted, or when flow control has been asserted by the receiver. If flow-control is asserted, the wire 320 is driven to a low voltage level by the receiver RTS driver 336 during the stop bit 344b and/or before the next start bit 342c is asserted. The second LM-UART 322 may de-assert flow control by driving the wire 320 to the high voltage level before disabling the RTS driver 336.

Interconnections Using Different UART Types

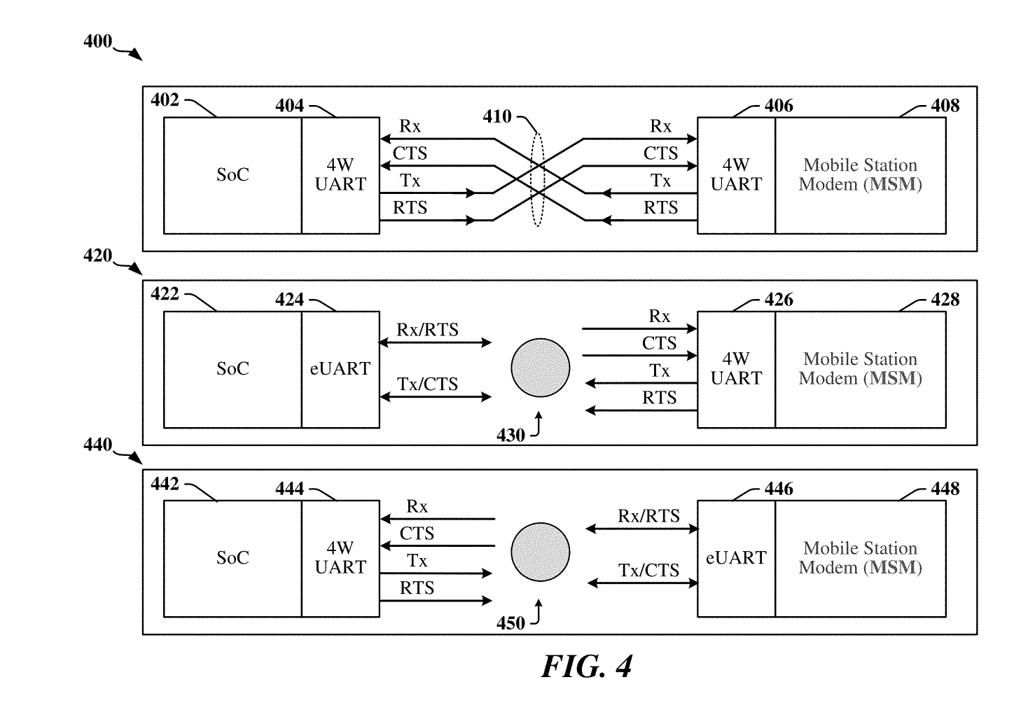

Various apparatus may be assembled using ICs, SoCs and other components that communicate using UARTs. In some instances. ICs, SoCs and other components use different types of UART. FIG. 4 illustrates different configurations 400, 420, 440 of a mobile device in which at least one component has a 4-wire UART. The first configuration 400 illustrates a conventional apparatus in which two devices 402 and 408 are equipped with 4-wire UARTs 404, 406 and coupled through a 4-wire bus 410. In the example, a first device 402 may be an SoC that includes an application processor, while the second device 408 may be mobile station modem (MSM) that is used for radio frequency (RF) communication. Here, the first device 402 includes a 4-wire UART 404 coupled to the 4-wire UART 406 of the second device 408 in general accordance with the first example 200 illustrated in FIG. 2.

In the second configuration 420, an SoC 422 includes an enhanced, 2-wire UART 424 while the MSM 428 has a 4-wire UART 426. In the third configuration, the SoC 442 includes a 4-wire UART 444 while the MSM 448 has an enhanced, 2-wire UART 446. In the second configuration 420 and the third configuration 440, both 2-wire and 4-wire configurations for the interconnections 430, 450 between the UARTs 424/426 or 444/446 would be incompatible with one of the UARTs 424/426 or 444/446, since the 4-wire UARTs 426, 444 use a hardware flow-control mechanism while the 2-wire UARTs 424, 446 expect flow-control information to be multiplexed with data packets.

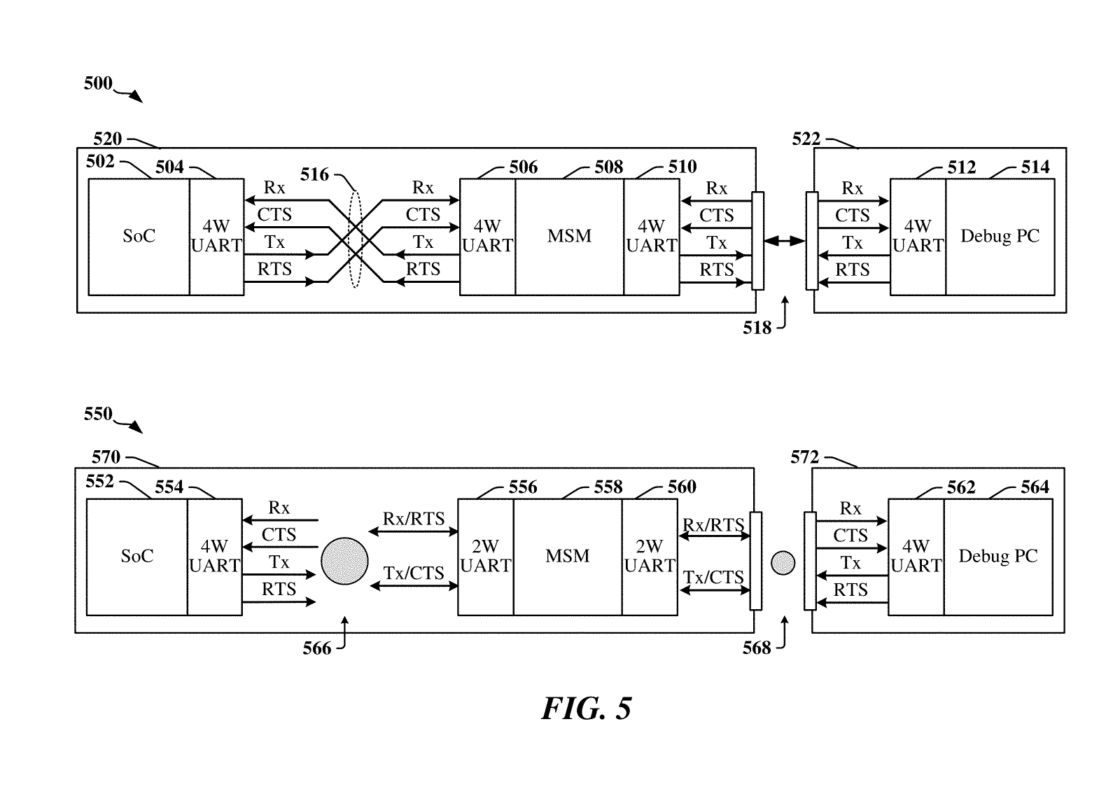

FIG. 5 illustrates additional configurations 500, 550 in which an apparatus 520, 570, is adapted to be coupled to test equipment 522, 572. The first configuration 500 illustrates a conventional apparatus 520 in which two devices 502 and 508 are equipped with 4-wire UARTs 504, 506 and coupled through 4-wire bus 516. In the example, a first device 502 may be an SoC that includes an application processor, while the second device 508 may be an MSM that is used for RF communication. The apparatus 520 may include an additional 4-wire UART 510 that is available for connecting the apparatus 520 to test equipment 522. In one example, the test equipment 522 includes a processing system such as a personal computer (PC) 514 equipped with a 4-wire UART 512. The apparatus 520 and test equipment 522 may be coupled using a cable 518. In one example, the cable 518 may be configured as a null-modem cable where Rx and Tx wires are crossed between cable ends and the RTS and CTS wires are crossed between the cable ends.

The second configuration 550 in FIG. 5 illustrates an example of an apparatus 570 that includes an MSM 558 equipped with enhanced, 2-wire UARTs 556, 560. Here, a 2-wire or 4-wire connection 566 between the 4-wire UART 554 associated with the conventional SoC 552 and a first 2-wire UART 556 of the MSM 558 typically can not accommodate the hardware flow-control mechanism expected by the 4-wire UART 554 and the line-multiplexed flow-control mechanism expected by the 2-wire UART 556. The test equipment 572 may include a PC 564 that uses a 4-wire interface to communicate with the apparatus 570. In the second configuration 550, a 2-wire or 4-wire cable 568 coupling the 4-wire UART 562 of the test equipment 572 to the second 2-wire UART 560 of the apparatus 570 cannot typically accommodate or reconcile a hardware flow-control mechanism expected by the 4-wire UART 562 with a line-multiplexed flow-control mechanism expected by the 2-wire UART 560.

According to certain aspects disclosed herein, a bridge circuit may be used to couple 4-wire UARTs to 2-wire line-multiplexed UARTs. The bridge circuit may be incorporated in one or more UARTs, SoCs, ICs, circuit boards, and/or cables in order to support interconnections between different types of UARTs. In some instances, the bridge circuit may be used with a connector to provide an automatically configurable interface between UARTs. The bridge circuit typically provides an appearance of a null-modem connection to the connected devices. In one example, bridging circuits may be adapted to couple the SoC 552 and MSM 558 and/or to support connection of the test equipment 572 to the apparatus 570 through the 2-wire UART 560. A cable may be adapted to include one or more bridging circuits that enable test equipment 522, 572 to communicate using a 4-wire interface between the UART 560 with either a 4-wire UART 510 or a 2-wire UART 560.

LM-UART to 4-Wire UART Bridging Example

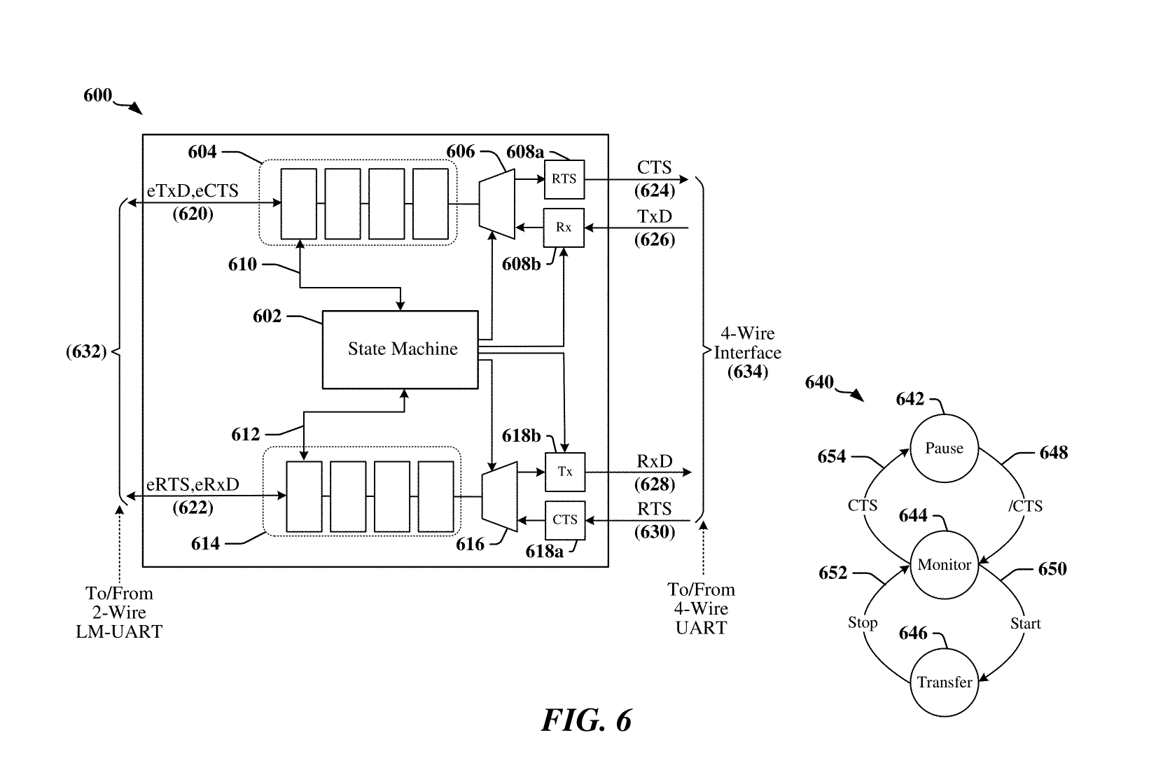

FIG. 6 illustrates an example of a bridge circuit 600 provided in accordance with certain aspects disclosed herein. The bridge circuit 600 may be employed to enable full-duplex communication between a 2-wire LM-UART and a 4-wire HS-UART with flow control. In one example, the bridge circuit 600 may be implemented in a programmable logic device (PLD).

The operation of the bridge circuit 600 may be controlled by a state machine 602 or other processor, sequencer, or controller. The state machine 602 may be configured to monitor state information of transmitter circuits 610 and/or receiver circuits 614, including the occupancy state of buffers included in the transmitter circuits 604 and/or receiver circuits 614. The state machine 602 may control the operation of multiplexers 606, 616 and may select a mode of operation for line drivers and/or receivers. In one example, an RTS driver 608a is coupled to the CTS wire 624 of a 4-wire UART, an Rx data receiver 608b is coupled to the TxD wire 626 of the 4-wire UART, a Tx data driver 618b is coupled to the RxD wire 628 of the 4-wire UART, and a CTS receiver 618a is coupled to the RTS wire 630 of the 4-wire UART.

In an example where the 4-wire UART has data to transmit, the state machine 602 may cause the RTS driver 608a to drive a high logic level on the CTS wire 624 of the 4-wire UART after determining that flow-control has not been asserted by the 2-wire UART, or has been de-asserted after assertion by the 2-wire UART. The 2-wire UART asserts and de-asserts flow control using the eTxD wire 620 to signal enhanced CTS (eCTS) state between transmissions of data packets. The state machine 602 may control a first multiplexer 606 to select buffers in the transmitter circuit 604 as a destination for a data packet to be received from the TxD wire 626 of the 4-wire UART through the Rx data receiver 608b. The data may then be transmitted on the eTxD wire 620 to the 2-wire UART. When flow control has been asserted on the eTxD wire 620 of the 2-wire UART, or when occupancy of the buffers in the transmitter circuit 604 exceeds a threshold level, the state machine 602 may use the RTS driver 608a to drive the CTS wire 624 to a low logic level in order to signal the 4-wire UART to stop transmission.

In an example where the 2-wire UART has data to transmit, the state machine 602 may receive a signal from the CTS receiver 618a indicating that the 4-wire UART has asserted a high logic level on the RTS wire 630. The state machine 602 may then de-assert flow-control (eRTS) and/or refrain from asserting flow control (eRTS) on the enhanced receiver wire (eRxD wire 622) between transmissions by the 2-wire UART. The 2-wire UART may transmit one or more packets of data over the eRxD wire 622. Data packets received from the 2-wire UART are transmitted through the Tx data driver 618b over the RxD wire 628 of the 4-wire UART. If the 4-UART drives the RTS wire 630 low, or if the buffers in the receiver circuit 614 are filling, the state machine may assert flow control (eRTS) by driving the eRxD wire 622 to a low logic level between data packets received from the 2-wire UART.

FIG. 6 includes a state diagram 640 that illustrates an example of the operation of the state machine 602 of the bridge circuit 600. In this example, the state machine 602 may be in one of three states 642, 644, 646. In a transfer state 646 the bridge circuit 600 transmits a character, in a monitor state 644 the bridge circuit 600 state monitors signaling state, and in a pause state 642, the bridge circuit 600 waits for a period of time. The pause state may be entered when flow control is asserted by the LM-UART, for example. In one example, the state machine 602 may cause the RTS driver 608a of the bridge circuit 600 to assert a low logic level on the CTS wire 624 of the 4-wire interface 634 when entering 654 the pause state 642. The state machine 602 may cause the RTS driver 608a to assert a high logic level on the CTS wire 624 of the 4-wire interface 634 when exiting 648 the pause state 642. In another example, the state machine 602 may enter the transfer state 646 after flow control is de-asserted by the two-wire interface 632. Having entered the transfer state 646, the bridge circuit 600 may commence transmitting data to the 2-wire UART. The same state machine 602 or a different state machine may control processing of data transmissions by the 2-wire UART. For example, the state machine 602 may enter the transfer state 646 after asserting enhanced RTS (eRTS) in order to cause the bridge circuit 600 to receive data from the 2-wire UART.

According to certain aspects, one or more bridge circuits may be deployed within an apparatus to permit the apparatus to dynamically configure the interconnections associated with constituent devices of the apparatus. In one example, bridging between 4-wire UARTs and 2-wire UARTs is enabled when differences in UART types is detected or signaled to the apparatus. In the third configuration 440 illustrated in FIG. 4, for example, the SoC 442 configured with a 4-wire UART 444 may enable bridging when the SoC 442 is required to communicate with the MSM 448 that uses a 2-wire UART 446. In some instances, a bridge circuit may provide a pass-through mode for interconnecting a pair of 4-wire UARTs, and/or for interconnecting one or two pairs of 2-wire UARTs using the 4 wires allocated for a 4-wire interface.

A bridge circuit used to couple the various components within a single device, as illustrated in FIG. 4, may be configured during assembly, with no need for reconfiguration in normal use. In some implementations, a bridge circuit used to interconnect components of different devices may be dynamically reconfigured. In the configurations 500, 550 illustrated in FIG. 5 for example, external test equipment 522, 572 can be coupled to an apparatus 520, 570 using an external cable. According to certain aspects disclosed herein, one or more one or more bridge circuits may be configured to support the connection of components in an apparatus to external equipment using any type of UART.

Examples of Apparatus Incorporating a Bridge Circuit

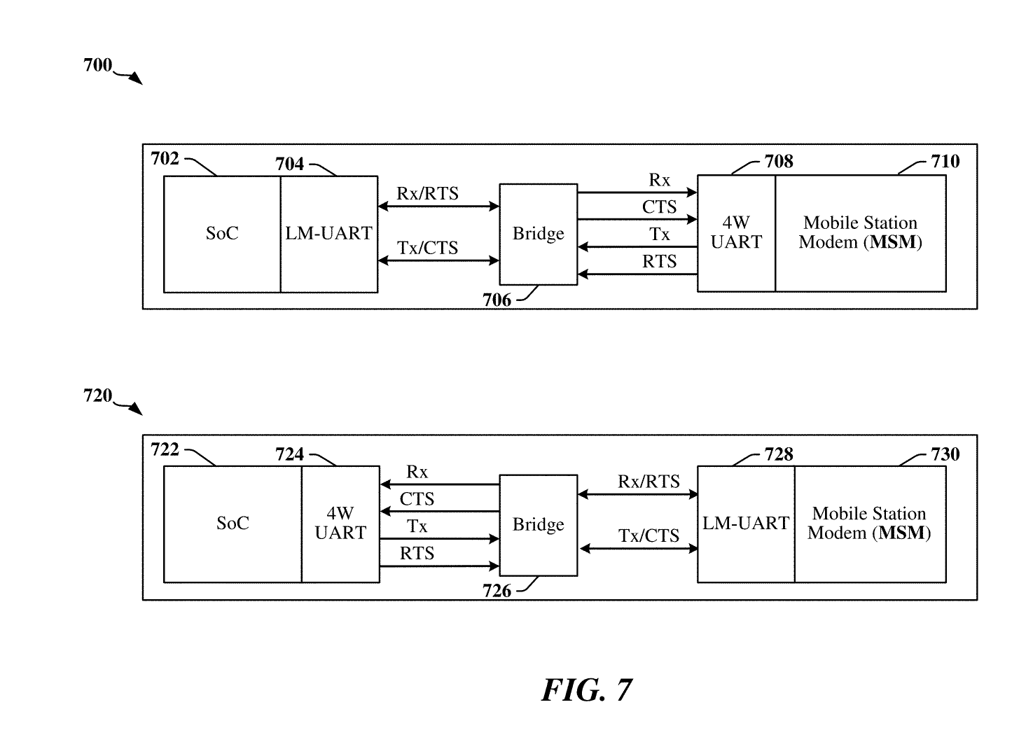

In accordance with certain aspects described herein, the bridge circuit 600 illustrated in FIG. 6 may be deployed within an apparatus. FIG. 7 illustrates two examples of apparatus 700, 720 in which a bridge circuit 706, 726 is used to interconnect an LM-UART 704, 728 with a 4-wire UART 708, 724. In the first example, the apparatus 700 includes an SoC 702 that has an enhanced, 2-wire LM-UART 704 while the MSM 710 has a 4-wire UART 708. In the second example, the SoC 722 includes a 4-wire UART 724 while the MSM 730 has an enhanced, 2-wire LM-UART 728.

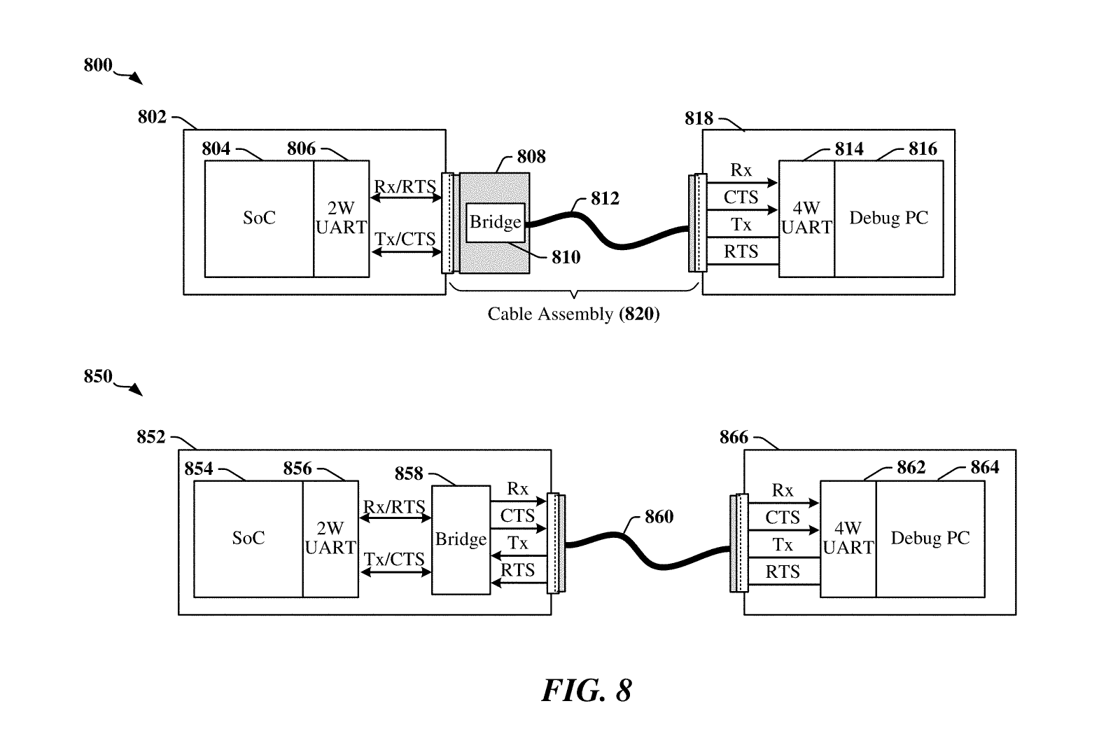

FIG. 8 illustrates examples of configurations 800, 850 of apparatus 802, 852 and test equipment 818, 866. The first configuration 800 illustrates test equipment 818 that includes a personal computer 816 or another suitable type of processing device. The test equipment 818 communicates with target apparatus 802 using a 4-wire UART 814. The apparatus 802 may include an SoC 804 that is configured to communicate with the test equipment 818 through a 2-wire LM-UART 806. In this configuration 800, a cable assembly 820 includes a bridge circuit 810 provided in a connector or at some point along the cable 812. The bridge circuit 810 may be installed on a circuit board 808, for example.

The second configuration 850 illustrates test equipment 866 that includes a personal computer 864 or other suitable processing device. The test equipment 866 communicates with target apparatus 852 using a 4-wire UART 862. The apparatus 802 may include a device such as an SoC 854 that is configured to communicate with the test equipment 866 through a 2-wire LM-UART 856. In this configuration 850, the bridge circuit 858 is provided within the apparatus 852. Accordingly, a 4-wire null-modem cable 860 may be used to connect the apparatus 852 to the test equipment 866.

Examples of Connector Systems Used with a Bridge Circuit

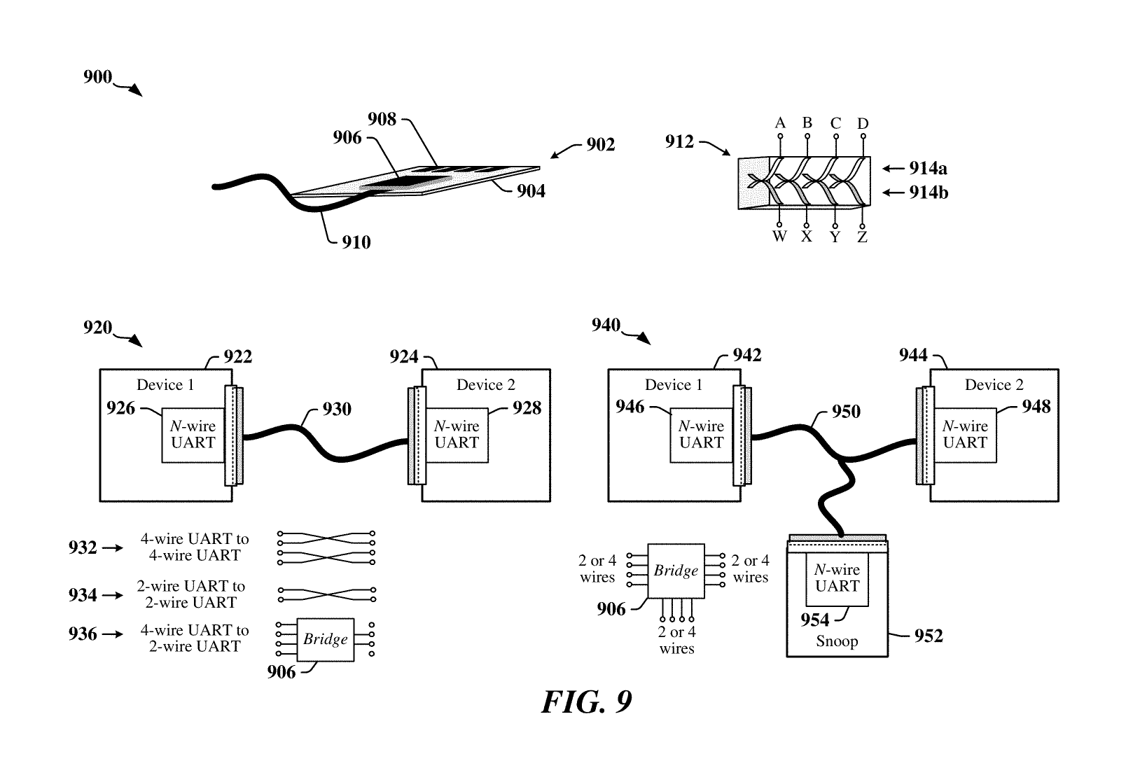

FIG. 9 illustrates an example of a connector system 900 that may be used to connect the test equipment 818, 866 of FIG. 8 to target apparatus 802, 852, where the UARTs 806, 814, 856, 862 that are to be interconnected may include some combination of 4-wire UARTs and 2-wire LM-UARTs. In the example, a cable assembly 902 includes a plate or blade 904 that may comprise a circuit board, chip carrier or substrate. The blade 904 carries one or more bridge circuits 906, which may be provided in a PLD or other IC device. The bridge circuits 906 may be configured to couple signals transmitted over a cable 910. The blade 904 may have contacts 908 deployed on one or more surfaces. For example, the contacts 908 may be provided on upper and lower surfaces of the blade 904. The contacts 908 may be configured to mate with corresponding contacts 914a, 914b of a connector 912 provided on a target apparatus.

The connector 912 has two sets of normally-closed contacts 914a, 914b that each includes at least 4 opposing pairs of contacts. For example, in normally-closed configuration, the terminals A, B, C, D are connected to corresponding terminals W, X, Y, Z, providing connections between A and W, B and X, C and Y, and D and Z. When the blade 904 is inserted into the connector, the connections between A and W, B and X, C and Y, and D and Z are broken and a new configuration of connections is established by the bridge circuits 906 and/or other circuits provided on the blade 904.

In some examples, the blade 904 may disconnect a pair of UARTs connected by traces or wiring on a circuit board within a single device, where the connection path between the pair of UARTs includes the connector 912. Insertion of the blade 904 of the cable assembly 902 into the connector 912 can change certain aspects of the connection path between the pair of UARTs. In one example, insertion of the cable assembly 902 may establish communication between one or more UARTs and the test equipment. In another example, insertion of the cable assembly 902 may provide a snooping capability for test equipment, where the test equipment monitors signals transmitted through the connector 912. In the latter example, the original configuration of connections (A-W, B-X, C-Y, and D-Z) is preserved and one or more of the connections are tapped to permit monitoring by the test equipment. In various configurations, the bridge circuits 906 may be adapted to bridge between 4-wire and 2-wire UARTs in accordance with certain aspects disclosed herein.

Two generalized device configurations 920 and 940 are illustrated in FIG. 9. In a first configuration 920, a simple connection is provided between a first device 922 and a second device 924. In one example, the first device 922 may be the subject of testing using the second device 924, which may be a component of test equipment. In some instances, the devices 922, 924 are used only during testing. In another example, a third device (not shown) may be connected to the first device 922 or the second device 924 when no cable is inserted into the connector 912. The cable assembly 930 includes one or more bridge circuits 906 that may be configured to support the different types of UART that may be used by the two devices 922, 924. In one wiring configuration 932, both devices 922, 924 use a 4-wire UART, such that bridging is not required and the cable assembly 930 is configured to operate as a 4-wire null-modem cable. In another wiring configuration 934, both devices 922, 924 use a 2-wire LM-UART, such that bridging is not required and the cable assembly 930 is configured to operate as a 2-wire null-modem cable. In another wiring configuration 932, the first device 922 has a 4-wire UART 926, the second device 924 has a 2-wire LM-UART 928, and a bridge circuit 906 is enabled. In one example, wiring configurations 932, 934, 946 may be selected by controlling a semiconductor switch matrix within the bridge circuit 906 or in another circuit provided on the blade 904.

In the second configuration 940, test equipment 952 is inserted into the connection between a first device 942 and a second device 944. In one example, the first device 922 and second device may be collocated in the same apparatus, and a connector 912 is included in the apparatus to enable test equipment to be connected for snooping or individual testing of one or both devices 942, 944. The illustrated cable assembly 950 relates to an example in which two devices 942, 944 are normally connected using a cable. In some instances, the connection between the two devices 942, 944 is provided as traces or wiring on a circuit board, substrate, chip carrier, etc., and the cable assembly 950 has two ends, one end connecting to the test equipment 952, the other inserted into the connector 912. The test equipment 952 may be configurable for snooping on the connection between the two devices 942, 944. In the second configuration 940, the cable assembly 950 may include one or more bridge circuits 906 that can be configured to support different types of UART used by the two devices 942, 944 and by the test equipment 952. One or more of the devices 942, 944 or the test equipment 952 may use a 4-wire UART, and one or more of the devices 942, 944 or the test equipment 952 may use a 2-wire LM-UART. The bridge circuits 906 may be configured to bridge between any combination of 4-wire UARTs and 2-wire LM-UARTs.

The connector system 900 may support other configurations of devices. For example, the connector 912 may be used to selectively couple four 2-wire LM-UARTs in one mode and two 4-wire UARTs in another mode. The bridge circuit 906 may include multiple bridges to support different combinations of UARTs.

The contacts 914a, 914b of the connector 912 may be formed from spring leaves that default to the closed configuration (normally-closed). The spring leaves may be constructed to produce sufficient force on opposing contacts 914b, 914a or on the contacts 908 provided on the blade 904 to ensure a low-impedance connection. Each spring leaf contact 914a exerts a counteracting force on its opposing spring leaf contact 914b in the connector. The spring leaf contacts 914a, 914b may be fabricated using magnetic materials that provide bounce-free connections. The connector 912 and blade 904 may include magnetic or electromagnetic components that fasten the connector 912 and blade 904 when connected. The connector 912 may have a shroud that protects the internal components from external interference or from mechanical interactions with unrelated objects.

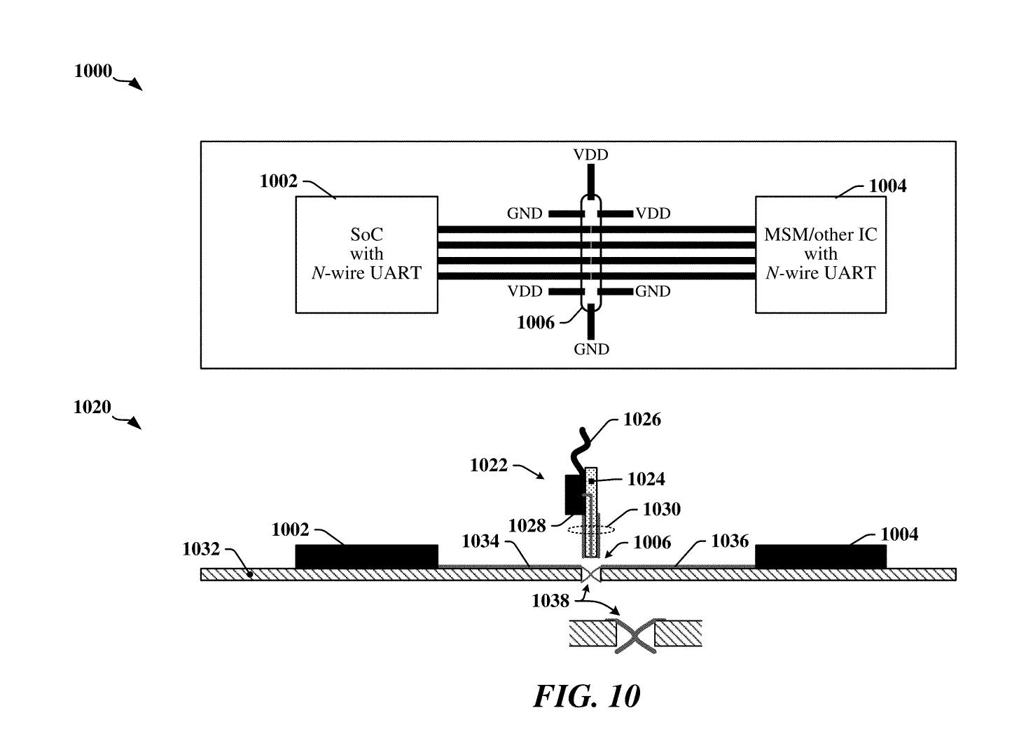

FIG. 10 provides different views 1000, 1020 of an example of a shroud-less connector that may be used to connect external equipment to an apparatus that includes one or more interconnected devices 1002, 1004. Each device 1002, 1004 includes a UART which may be a 4-wire UART or a 2-wire LM-UART. The devices 1002, 1004 may be arranged in any configuration or orientation on a circuit board, substrate or chip carrier 1010. Traces and/or wires 1032, 1034 may connect each device 1002, 1004 to a connector formed on the circuit board, substrate or chip carrier 1010. The connector is formed around an opening 1006 through the circuit board, substrate or chip carrier 1010. The opening 1006 may be configured to receive a blade 1024 of a connector assembly 1022. The connector has contacts 1036, which may include spring-loaded leaves mounted within the opening 1006. At least four pairs of contacts 1036 are closed when the blade 1024 is not present. When the blade 1024 is inserted into the opening 1006, the normally closed contacts are separated and may engage corresponding contacts 1030 on the blade 1024. One or more bridge circuits provided in a PLD 1028 or other device may reestablish connections between the devices 1002, 1004 (when snooping is to be performed, for example). The bridge circuits in the PLD 1028 may redirect connections associated with one or more of the devices 1002, 1004, where desired or required by the application. The bridge circuits in the PLD 1028 may provide a set of signals to external equipment through a cable 1026. In one example, test equipment may be connected to one or more devices 1002, 1004 for test purposes. In another example, the test equipment may receive signals representative of the signaling between two or more devices 1002, 1004, when the test equipment is snooping.

The contacts 1036 may be fabricated using magnetic materials that can assist in preventing switch bouncing. The connector may have a pin-out that avoids orientation sensitivity, where the blade 1024 can be inserted in either orientation without compromising power connections between devices. In some instances, the connector can be keyed through geometry to establish electrical encoding of plug-in polarity. The PLD 1028 may include circuits and controllers that automatically identify topology of the connectors, based on orientation. The PLD may also include a processor, sequencer, controller, state machine, or the like, that can automatically configure the function of bridge circuits in the PLD 1028.

Examples of Bridging Circuit Operations

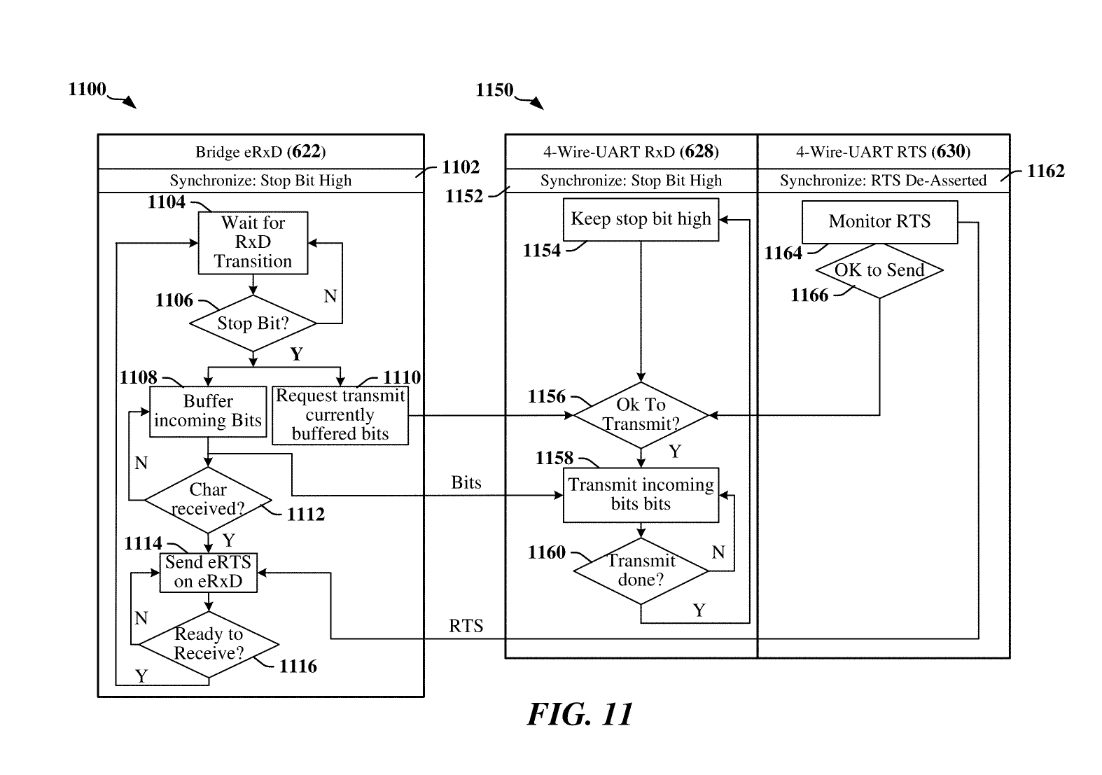

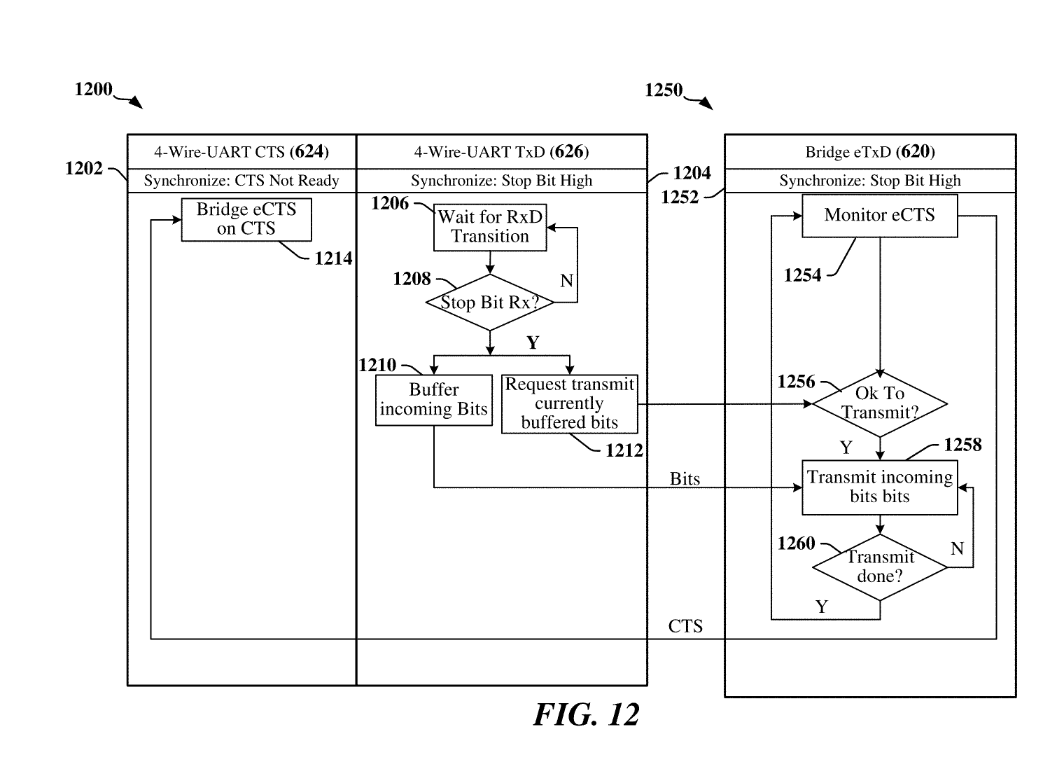

With continued reference to FIG. 6, FIGS. 11 and 12 provide examples of the operation of a bridging circuit 600 used to interconnect a 4-wire UART with a 2-wire LM-UART. The bridge circuit 600 includes a 2-wire interface 632 that may be configured as a 2-wire LM-UART interface. Each wire 620, 622 coupled to the 2-wire interface 632 is operated as a half-duplex communication link with flow control. In combination, the two wires 620, 622 operate as a full-duplex communication link with flow control.

The enhanced transmitter wire (eTxD wire 620) is used to transmit data packets and receive eCTS information between data packet transmissions. The enhanced receiver wire (eRxD wire 622) is used to receive data packets and transmit eRTS information between data packets. The bridge circuit 600 includes a 4-wire interface 634 that may be coupled to a 4-wire UART. The bridge circuit 600 uses the Rx data receiver 608b to receive data transmitted by the 4-wire UART on its transmit data line (i.e., the TxD wire 626), and uses the Tx data driver 618b to transmit data to the receiver data line of the 4-wire UART (i.e., the RxD wire 628). Flow control signals are communicated on different wires 624, 630. The RTS signal is transmitted by the 4-wire UART on its RTS wire 630 and received by the bridge circuit 600 using the CTS receiver 618a. The bridge circuit 600 uses the RTS driver 608a to transmit a signal on the CTS wire 624 of the 4-wire UART.

FIG. 11 illustrates an example of bridging operations associated with the eRxD wire 622 of the bridge circuit 600. The bridging operations may be controlled by a processor, state machine or other controller. Control of the LM-UART line (i.e., the eRxD wire 622) is illustrated generally at 1100, while control of the corresponding lines in the 4-wire UART is illustrated generally at 1150. Initially, each wire 622, 628, 630 is brought into synchronization at blocks 1102, 1152 and 1162. In one example, synchronization may be accomplished when a stop bit is received (the wire is in a high state) and the RTS signal is not asserted. The 4-wire UART and 2-wire LM-UART are operated in a quasi-synchronous mode through the synchronization shown at blocks 1102, 1152 and 1162.

At block 1104, a controller may wait until a transition occurs on the eRxD wire 622 before receiving bits. At block 1106, the controller may determine whether a Stop bit has been detected. The controller may continue to collect bits if no Stop bit is detected. When a stop bit is detected at block 1106, the controller may provide the received bits in a bit FIFO buffer at block 1108, while initiating a request to transmit the bits at block 1110. The request is handled by the 4-wire interface of the bridge circuit 600. At block 1112, the controller may determine whether a complete character has been received and continues buffering at block 1108 until the character is completely received. At block 1114, the controller may transmit eRTS information on the eRxD wire 622 after the character has been received. The eRTS information is obtained from the 4-wire interface of the bridge circuit 600 where, at block 1164 the RTS wire 630 controlled by the 4-wire UART is monitored. At block 1166, the controller may signal the data transmitter portion of the 4-wire interface of the bridge circuit 600 when RTS is asserted on the RTS wire 630. At block 1156, the information regarding state of the RTS wire 630 (i.e., asserted) and the request issued at block 1110 are received and transmission of the data bits buffered at block 1108 may commence on the RxD wire 628, and may continue until the controller determines at block 1160 that all bits have been transmitted.

FIG. 12 illustrates an example of bridging operations associated with the eTxD wire 620 of the bridge circuit 600. The bridging operations may be controlled by a processor, state machine or other controller. Control of the LM-UART line (i.e., the eTxD wire 620) is illustrated generally at 1250, while control of the corresponding lines in the 4-wire UART is illustrated generally at 1200. Initially, each wire 620, 624, 626 is brought into synchronization at blocks 1202, 1204 and 1252. In one example, synchronization may be accomplished when the stop bit is in a high state and the CTS wire 624 is in a not-ready state. The 4-wire UART and 2-wire LM-UART are operated in a quasi-synchronous mode through the synchronization shown at blocks 1202, 1204 and 1252.

At block 1206, a controller may wait until a transition occurs on the TxD wire 626 of the 4-wire UART before receiving bits. At block 1208, the controller may determine whether a Stop bit has been detected. The controller may continue to collect bits if no Stop bit is detected. When a stop bit is detected at block 1208, the controller may provide the received bits in a FIFO buffer at block 1210, while initiating a request to transmit the bits at block 1212. The request is handled by the 2-wire interface of the bridge circuit 600.

At block 1254, the controller may monitor the signaling status of eCTS, which is provided to determine whether bits can be sent to the 2-wire UART. At block 1256, the controller receives the request transmitted at block 1212 and the indication of eCTS and determines when data bits buffered at block 1210 can be transmitted over the 2-wire interface at block 1258. Transmission continues until the controller determines at block 1260 that transmission is complete. At block 1254, eCTS information received from the eTxD wire 620 may then be monitored, and the eCTS information may be bridged to the 4-wire interface of the bridge circuit 600, where at block 1214 the controller may control the state of the CTS wire 624, which is an input to the 4-wire UART.

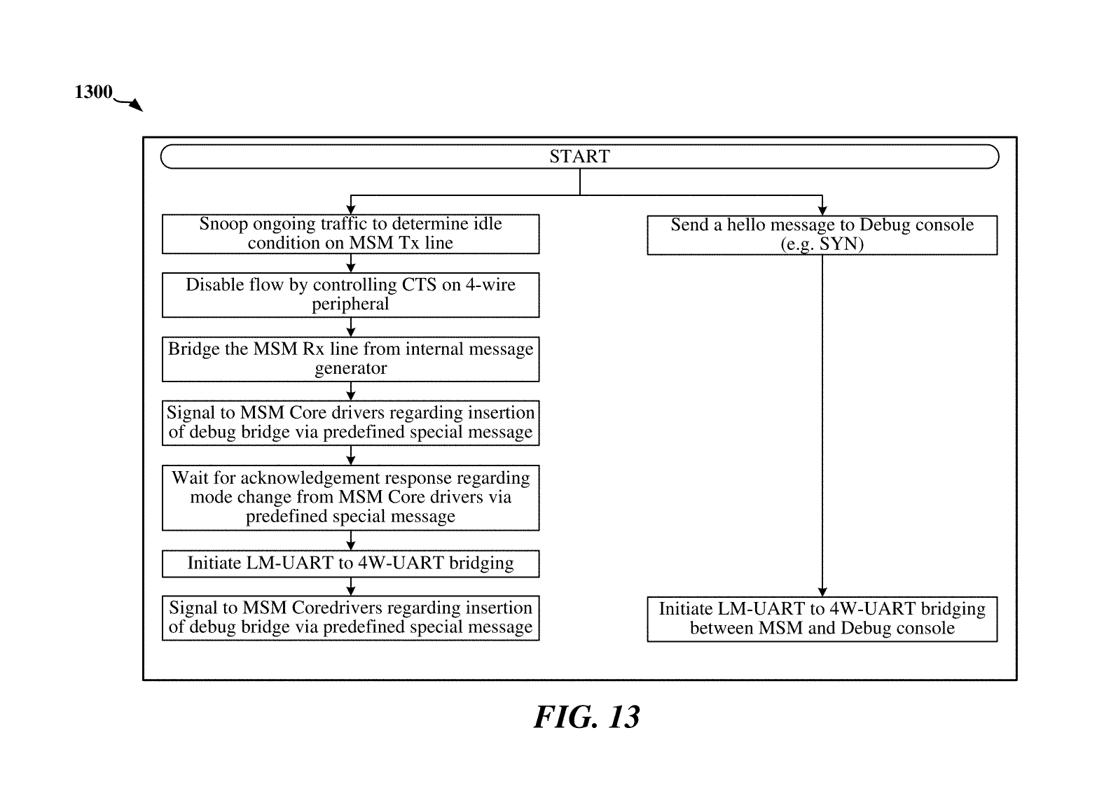

FIG. 13 is a flow diagram 1300 illustrating an example of a hot-plug process that may be implemented to support connection of test equipment in the manner illustrated in FIGS. 9 and 10. In this example, the bridge circuit 600 may include an internal message generator that is used to communicate with low-level drivers of an MSM or SoC device. In one example, the low-level drivers are included in a board support package (BSP) that may describe characteristics of the physical devices in an apparatus, identify capabilities of the physical devices and provide programming interfaces that permits high-level applications to operate and control the physical devices. The BSP must typically be updated to account for the insertion of a new UART and/or replacement of a previously identified UART in the apparatus. Special messages may be communicated using combinations of characters that are filtered by low-level drivers, and/or that relate to archaic link control protocols.

Examples of Processing Circuits and Methods

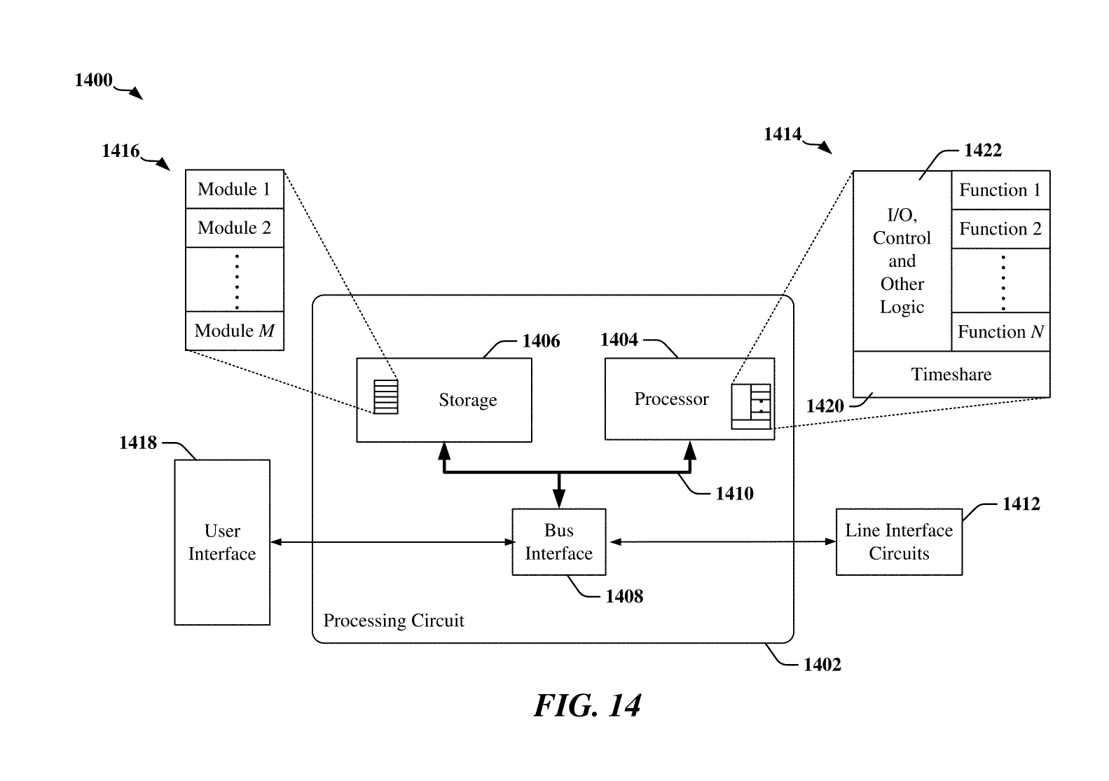

FIG. 14 is a diagram illustrating an example of a hardware implementation for an apparatus 1400 employing a processing circuit 1402 that may be configured to perform one or more functions disclosed herein. In accordance with various aspects of the disclosure, an element, or any portion of an element, or any combination of elements as disclosed herein may be implemented using the processing circuit 1402. The processing circuit 1402 may include one or more processors 1404 that are controlled by some combination of hardware and software modules. Examples of processors 1404 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1404 may include specialized processors that perform specific functions, and that may be configured, augmented or controlled by one of the software modules 1416. The one or more processors 1404 may be configured through a combination of software modules 1416 loaded during initialization, and further configured by loading or unloading one or more software modules 1416 during operation.

In the illustrated example, the processing circuit 1402 may be implemented with a bus architecture, represented generally by the bus 1410. The bus 1410 may include any number of interconnecting buses and bridges depending on the specific application of the processing circuit 1402 and the overall design constraints. The bus 1410 links together various circuits including the one or more processors 1404, and storage 1406. Storage 1406 may include memory devices and mass storage devices, and may be referred to herein as computer-readable media and/or processor-readable media. The bus 1410 may also link various other circuits such as timing sources, timers, peripherals, voltage regulators, and power management circuits. A bus interface 1408 may provide an interface between the bus 1410 and one or more transceivers 1412. A transceiver 1412 may be provided for each networking technology supported by the processing circuit. In some instances, multiple networking technologies may share some or all of the circuitry or processing modules found in a transceiver 1412. Each transceiver 1412 provides a means for communicating with various other apparatus over a transmission medium. Depending upon the nature of the apparatus 1400, a user interface 1418 (e.g., keypad, display, speaker, microphone, joystick) may also be provided, and may be communicatively coupled to the bus 1410 directly or through the bus interface 1408.

A processor 1404 may be responsible for managing the bus 1410 and for general processing that may include the execution of software stored in a computer-readable medium that may include the storage 1406. In this respect, the processing circuit 1402, including the processor 1404, may be used to implement any of the methods, functions and techniques disclosed herein. The storage 1406 may be used for storing data that is manipulated by the processor 1404 when executing software, and the software may be configured to implement any one of the methods disclosed herein.

One or more processors 1404 in the processing circuit 1402 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1406 or in an external computer-readable medium. The external computer-readable medium and/or storage 1406 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1406 may also include, by way of example, a carrier wave, a transmission line, and any other suitable medium for transmitting software and/or instructions that may be accessed and read by a computer. Computer-readable medium and/or the storage 1406 may reside in the processing circuit 1402, in the processor 1404, external to the processing circuit 1402, or be distributed across multiple entities including the processing circuit 1402. The computer-readable medium and/or storage 1406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1406 may maintain software maintained and/or organized in loadable code segments, modules, applications, programs, etc., which may be referred to herein as software modules 1416. Each of the software modules 1416 may include instructions and data that, when installed or loaded on the processing circuit 1402 and executed by the one or more processors 1404, contribute to a run-time image 1414 that controls the operation of the one or more processors 1404. When executed, certain instructions may cause the processing circuit 1402 to perform functions in accordance with certain methods, algorithms and processes described herein.

Some of the software modules 1416 may be loaded during initialization of the processing circuit 1402, and these software modules 1416 may configure the processing circuit 1402 to enable performance of the various functions disclosed herein. For example, some software modules 1416 may configure internal devices and/or logic circuits 1422 of the processor 1404, and may manage access to external devices such as the transceiver 1412, the bus interface 1408, the user interface 1418, timers, mathematical coprocessors, and so on. The software modules 1416 may include a control program and/or an operating system that interacts with interrupt handlers and device drivers, and that controls access to various resources provided by the processing circuit 1402. The resources may include memory, processing time, access to the transceiver 1412, the user interface 1418, and so on.

One or more processors 1404 of the processing circuit 1402 may be multifunctional, whereby some of the software modules 1416 are loaded and configured to perform different functions or different instances of the same function. The one or more processors 1404 may additionally be adapted to manage background tasks initiated in response to inputs from the user interface 1418, the transceiver 1412, and device drivers, for example. To support the performance of multiple functions, the one or more processors 1404 may be configured to provide a multitasking environment, whereby each of a plurality of functions is implemented as a set of tasks serviced by the one or more processors 1404 as needed or desired. In one example, the multitasking environment may be implemented using a timesharing program 1420 that passes control of a processor 1404 between different tasks, whereby each task returns control of the one or more processors 1404 to the timesharing program 1420 upon completion of any outstanding operations and/or in response to an input such as an interrupt. When a task has control of the one or more processors 1404, the processing circuit is effectively specialized for the purposes addressed by the function associated with the controlling task. The timesharing program 1420 may include an operating system, a main loop that transfers control on a round-robin basis, a function that allocates control of the one or more processors 1404 in accordance with a prioritization of the functions, and/or an interrupt driven main loop that responds to external events by providing control of the one or more processors 1404 to a handling function.

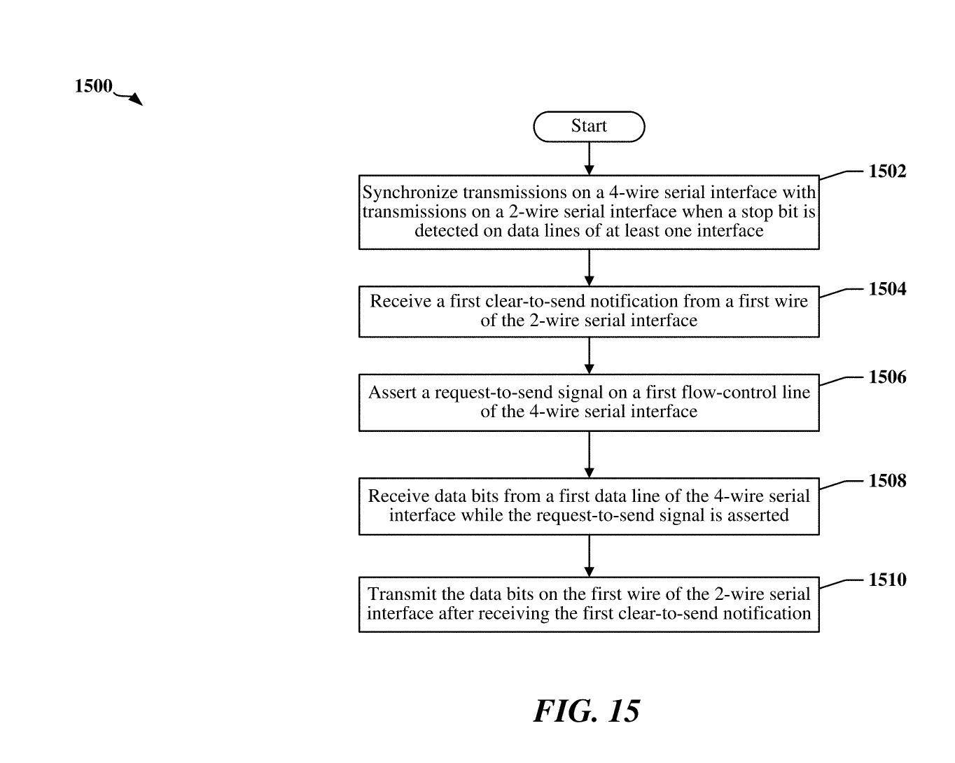

FIG. 15 is a flowchart 1500 of a method for managing bridging operations for serial data links. The method may be performed by a controller of the bridge circuit.

At block 1502, the controller may synchronize transmissions on a 4-wire serial interface with transmissions on a 2-wire serial interface when a stop bit is detected on data lines of at least one interface.

At block 1504, the controller may receive a first clear-to-send notification from a first wire of the 2-wire serial interface. The first clear-to-send notification may be received between 8-bit transmissions on the first wire of the 2-wire serial interface.

At block 1506, the controller may assert a request-to-send signal on a first flow-control line of the 4-wire serial interface. The request-to-send signal may be asserted when the first clear-to-send notification is received.

At block 1508, the controller may receive data bits from a first data line of the 4-wire serial interface while the request-to-send signal is asserted.

At block 1502, the controller may transmit the data bits on the first wire of the 2-wire serial interface after receiving the first clear-to-send notification.

In some examples, the controller may receive a second clear-to-send notification from the first wire of the 2-wire serial interface after the data bits have been transmitted on the first wire of the 2-wire serial interface. In response to the second clear-to-send notification, the controller may de-assert the request-to-send signal on the first flow-control line of the 4-wire serial interface.

In some examples, the controller may determine that a clear-to-send signal has been asserted on a second flow-control line of the 4-wire serial interface, transmit a first request-to-send notification over a second wire of the 2-wire serial interface, receive data bits from the second wire of the 2-wire serial interface after the first request-to-send notification has been transmitted, and transmit the data bits on a second data line of the 4-wire serial interface while the clear-to-send signal is asserted. The first request-to-send notification may be transmitted when the clear-to-send signal is asserted. The controller may determine that the clear-to-send signal has been de-asserted, and may transmit a second request-to-send notification over the second wire of the 2-wire serial interface after the data bits have been received and when the clear-to-send signal has been de-asserted. The first request-to-send notification may be transmitted between 8-bit packets received from the second wire of the 2-wire serial interface.

In some examples, the controller may identify a type of a first UART coupled to a first interface of the bridge circuit, identify a type of a second UART coupled to a second interface of the bridge circuit, and configure a bridging operation based on the type of the first UART and the type of the second UART. The controller may configure the first interface as a 2-wire interface when the first UART is a line-multiplexed UART. The controller may configure the first interface as a 4-wire interface when the first UART is not a line-multiplexed UART. The controller may configure the second interface as a 2-wire interface when the second UART is a line-multiplexed UART. The controller may configure the second interface as a 4-wire interface when the second UART is not a line-multiplexed UART.

In some instances, the controller may identify a change in the type of the first UART or the type of the second UART, and modify a bridging operation based on the change in the type of the first UART or the type of the second UART.

In some examples, configuring the bridging operation includes multiplexing onto a first wire of the first interface, a first data signal that is received from the second interface with a first flow-control signal that is transmitted on the second interface, and multiplexing onto a second wire of the first interface, a second data signal that is transmitted on the second interface with a second flow-control signal that is received from the second interface.

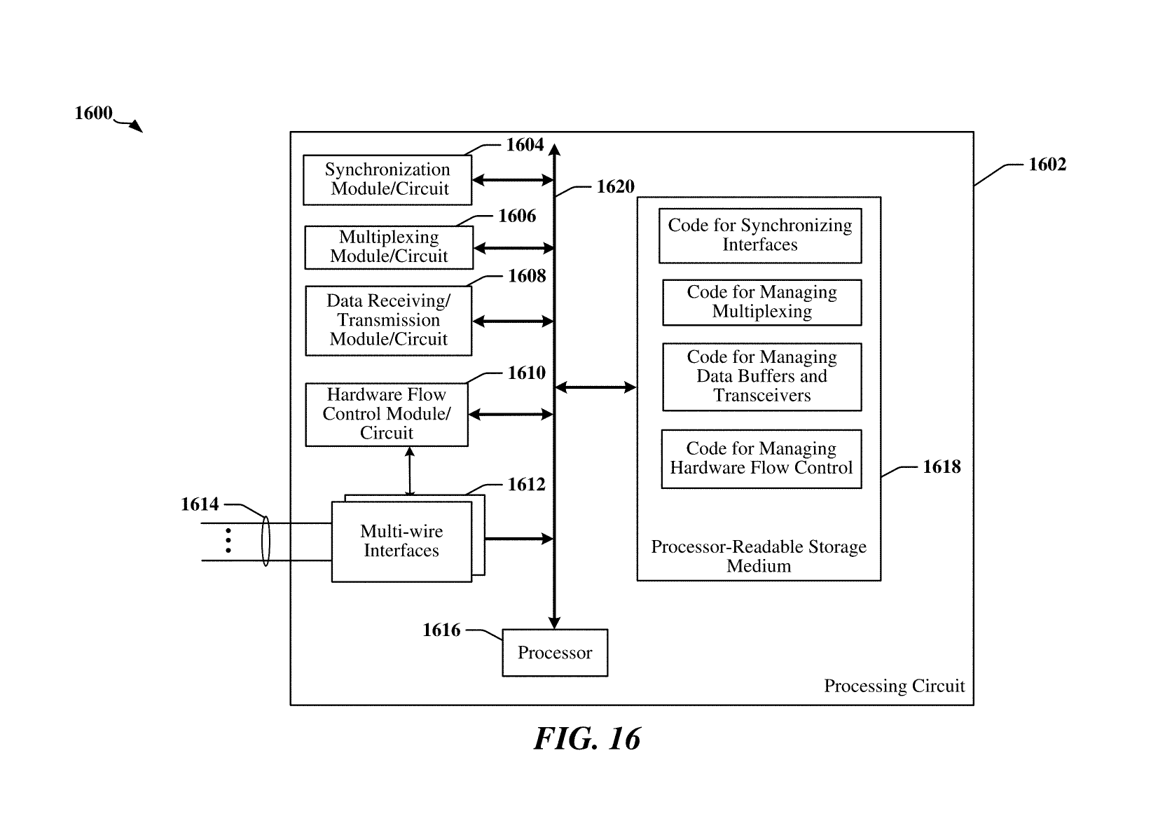

FIG. 16 is a diagram illustrating a simplified example of a hardware implementation for an apparatus 1600 employing a processing circuit 1602. The apparatus may implement a bridging circuit in accordance with certain aspects disclosed herein. The processing circuit typically has a controller or processor 1616 that may include one or more microprocessors, microcontrollers, digital signal processors, sequencers and/or state machines. The processing circuit 1602 may be implemented with a bus architecture, represented generally by the bus 1620. The bus 1620 may include any number of interconnecting buses and bridges depending on the specific application of the processing circuit 1602 and the overall design constraints. The bus 1620 links together various circuits including one or more processors and/or hardware modules, represented by the controller or processor 1616, the modules or circuits 1604, 1606 and 1608 and the computer-readable storage medium 1618. The apparatus may have a plurality of multi-wire interfaces 1612 adapted for full-duplex serial communication with flow control using a variable number of wires 1614 per interface 1612. The bus 1620 may also link various other circuits such as timing sources, peripherals, voltage regulators, and power management circuits, which are well known in the art, and therefore, will not be described any further.

The processor 1616 is responsible for general processing, including the execution of software, code and/or instructions stored on the computer-readable storage medium 1618. The computer-readable storage medium may include a non-transitory storage medium. The software, when executed by the processor 1616, causes the processing circuit 1602 to perform the various functions described supra for any particular apparatus. The computer-readable storage medium may be used for storing data that is manipulated by the processor 1616 when executing software. The processing circuit 1602 further includes at least one of the modules 1604, 1606, 1608 and 1610. The modules 1604, 1606, 1608 and 1610 may be software modules running in the processor 1616, resident/stored in the computer-readable storage medium 1618, one or more hardware modules coupled to the processor 1616, or some combination thereof. The modules 1604, 1606, 1608 and 1610 may include microcontroller instructions, state machine configuration parameters, or some combination thereof.

In one configuration, the apparatus 1600 includes a plurality of multi-wire interfaces 1612 and a controller or processor 1616. The apparatus may include a module or circuit 1604 configured to synchronize transmissions on a 4-wire serial interface with transmissions on a 2-wire serial interface when a stop bit is detected on data lines of at least one interface. The apparatus may include a module or circuit 1606 configured to multiplex onto a first wire of a first interface, a first data signal that is received from a second interface with a first flow-control signal that is transmitted on the second interface, and multiplex multiplexing onto a second wire of the first interface, a second data signal that is transmitted on the second interface with a second flow-control signal that is received from the second interface. The apparatus may include a module or circuit 1610 configured to assert a request-to-send signal on a first flow-control line of the 4-wire serial interface after receiving a first clear-to-send notification from a first wire of the 2-wire serial interface. The apparatus may include a module or circuit 1608 configured to receive data bits from a first data line of the 4-wire serial interface while the request-to-send signal is asserted, and transmit the data bits on the first wire of the 2-wire serial interface after receiving the first clear-to-send notification.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method performed by a bridge circuit, comprising:
synchronizing transmissions on a 4-wire serial interface with transmissions on a 2-wire serial interface when a stop bit is detected on data lines of at least one interface;
receiving a first clear-to-send notification from a first wire of the 2-wire serial interface;
asserting a request-to-send signal on a first flow-control line of the 4-wire serial interface;
receiving data bits from a first data line of the 4-wire serial interface while the request-to-send signal is asserted; and
transmitting the data bits on the first wire of the 2-wire serial interface after receiving the first clear-to-send notification.

2. The method of claim 1, wherein the request-to-send signal is asserted when the first clear-to-send notification is received.

3. The method of claim 1, further comprising:
receiving a second clear-to-send notification from the first wire of the 2-wire serial interface after the data bits have been transmitted on the first wire of the 2-wire serial interface; and
de-asserting the request-to-send signal on the first flow-control line of the 4-wire serial interface in response to the second clear-to-send notification.

4. The method of claim 1, wherein the first clear-to-send notification is received between 8-bit transmissions on the first wire of the 2-wire serial interface.

5. The method of claim 1, further comprising:
determining that a clear-to-send signal has been asserted on a second flow-control line of the 4-wire serial interface;
transmitting a first request-to-send notification over a second wire of the 2-wire serial interface;
receiving data bits from the second wire of the 2-wire serial interface after the first request-to-send notification has been transmitted; and
transmitting the data bits on a second data line of the 4-wire serial interface while the clear-to-send signal is asserted.

6. The method of claim 5, wherein the first request-to-send notification is transmitted when the clear-to-send signal is asserted.

7. The method of claim 5, further comprising:
determining that the clear-to-send signal has been de-asserted; and
transmitting a second request-to-send notification over the second wire of the 2-wire serial interface after the data bits have been received when the clear-to-send signal has been de-asserted.

8. The method of claim 5, wherein the first request-to-send notification is transmitted between 8-bit packets received from the second wire of the 2-wire serial interface.

9. The method of claim 1, further comprising:
identifying a type of a first universal asynchronous receiver/transmitter (UART) coupled to a first interface of the bridge circuit;
identifying a type of a second UART coupled to a second interface of the bridge circuit; and
configuring a bridging operation based on the type of the first UART and the type of the second UART.

10. The method of claim 9, further comprising:
configuring the first interface as a 2-wire interface when the first UART is a line-multiplexed UART; and
configuring the first interface as a 4-wire interface when the first UART is not a line-multiplexed UART.

11. The method of claim 9, further comprising:
configuring the second interface as a 2-wire interface when the second UART is a line-multiplexed UART; and
configuring the second interface as a 4-wire interface when the second UART is not a line-multiplexed UART.

12. The method of claim 9, further comprising:
identifying a change in the type of the first UART or the type of the second UART; and
modifying a bridging operation based on the change in the type of the first UART or the type of the second UART.

13. The method of claim 9, wherein configuring the bridging operation comprises:
multiplexing onto a first wire of the first interface, a first data signal that is received from the second interface with a first flow-control signal that is transmitted on the second interface; and
multiplexing onto a second wire of the first interface, a second data signal that is transmitted on the second interface with a second flow-control signal that is received from the second interface.

14. A bridge circuit, comprising:
a plurality of multi-wire interfaces; and
a controller configured to:
synchronize transmissions on a 4-wire serial interface with transmissions on a 2-wire serial interface when a stop bit is detected on data lines of at least one interface;
receive a first clear-to-send notification from a first wire of the 2-wire serial interface;
assert a request-to-send signal on a first flow-control line of the 4-wire serial interface;
receive data bits from a first data line of the 4-wire serial interface while the request-to-send signal is asserted; and
transmit the data bits on the first wire of the 2-wire serial interface after receiving the first clear-to-send notification.

15. The bridge circuit of claim 14, wherein the request-to-send signal is asserted when the first clear-to-send notification is received.

16. The bridge circuit of claim 14, wherein the controller is configured to:
receive a second clear-to-send notification from the first wire of the 2-wire serial interface after the data bits have been transmitted on the first wire of the 2-wire serial interface; and
de-assert the request-to-send signal on the first flow-control line of the 4-wire serial interface in response to the second clear-to-send notification.

17. The bridge circuit of claim 14, wherein the first clear-to-send notification is received between 8-bit transmissions on the first wire of the 2-wire serial interface.

18. The bridge circuit of claim 14, wherein the controller is configured to:
determine that a clear-to-send signal has been asserted on a second flow-control line of the 4-wire serial interface;
transmit a first request-to-send notification over a second wire of the 2-wire serial interface;
receive data bits from the second wire of the 2-wire serial interface after the first request-to-send notification has been transmitted; and
transmit the data bits on a second data line of the 4-wire serial interface while the clear-to-send signal is asserted.

19. The bridge circuit of claim 18, wherein the first request-to-send notification is transmitted when the clear-to-send signal is asserted.

20. The bridge circuit of claim 18, wherein the controller is configured to:
determine that the clear-to-send signal has been de-asserted; and
transmit a second request-to-send notification over the second wire of the 2-wire serial interface after the data bits have been received when the clear-to-send signal has been de-asserted.

21. The bridge circuit of claim 18, wherein the first request-to-send notification is transmitted between 8-bit packets received from the second wire of the 2-wire serial interface.

22. The bridge circuit of claim 14, wherein the controller is adapted to:
identify a type of a first universal asynchronous receiver/transmitter (UART) coupled to a first interface of the bridge circuit;
identify a type of a second UART coupled to a second interface of the bridge circuit; and
configure a bridging operation based on the type of the first UART and the type of the second UART.

23. The bridge circuit of claim 22, wherein the controller is adapted to:
configure the first interface as a 2-wire interface when the first UART is a line-multiplexed UART; and
configure the first interface as a 4-wire interface when the first UART is not a line-multiplexed UART.

24. The bridge circuit of claim 22, wherein the controller is configured to:
configure the second interface as a 2-wire interface when the second UART is a line-multiplexed UART; and
configure the second interface as a 4-wire interface when the second UART is not a line-multiplexed UART.

25. The bridge circuit of claim 22, wherein the controller is adapted to:
identify a change in the type of the first UART or the type of the second UART; and
modify a bridging operation based on the change in the type of the first UART or the type of the second UART.

26. The bridge circuit of claim 22, wherein the controller is adapted to:
multiplex onto a first wire of the first interface, a first data signal that is received from the second interface with a first flow-control signal that is transmitted on the second interface; and
multiplex onto a second wire of the first interface, a second data signal that is transmitted on the second interface with a second flow-control signal that is received from the second interface.

27. The bridge circuit of claim 22, wherein the controller is adapted to configure the bridging operation after a normally-closed connector is opened.

28. An apparatus comprising:
means for synchronizing transmissions on a 4-wire serial interface with transmissions on a 2-wire serial interface when a stop bit is detected on data lines of at least one interface;
means for receiving clear-to-send notifications from a first wire of the 2-wire serial interface;
means for transmitting the data bits on the first wire of the 2-wire serial interface after receiving the clear-to-send notification;
means for controlling a request-to-send signal on a first flow-control line of the 4-wire serial interface responsive to the clear-to-send notifications; and
means for receiving data bits from a first data line of the 4-wire serial interface while the request-to-send signal is asserted.

29. The apparatus of claim 28, further comprising:
means for monitoring a clear-to-send signal on a second flow-control line of the 4-wire serial interface;
means for transmitting request-to-send notifications over a second wire of the 2-wire serial interface;
means for receiving data bits from the second wire of the 2-wire serial interface after the request-to-send notification has been transmitted; and
means for transmitting the data bits on a second data line of the 4-wire serial interface while the clear-to-send signal is asserted.

30. A computer computer-readable storage medium comprising code for:
synchronizing transmissions on a 4-wire serial interface with transmissions on a 2-wire serial interface when a stop bit is detected on data lines of at least one interface;
receiving a clear-to-send notification from a first wire of the 2-wire serial interface;
asserting a request-to-send signal on a first flow-control line of the 4-wire serial interface;
receiving data bits from a first data line of the 4-wire serial interface while the request-to-send signal is asserted;
transmitting the data bits on the first wire of the 2-wire serial interface after receiving the clear-to-send notification;
determining that a clear-to-send signal has been asserted on a second flow-control line of the 4-wire serial interface;
transmitting a request-to-send notification over a second wire of the 2-wire serial interface;
receiving data bits from the second wire of the 2-wire serial interface after the request-to-send notification has been transmitted; and
transmitting the data bits on a second data line of the 4-wire serial interface while the clear-to-send signal is asserted.
